(19) United States
(12) Patent Application Publication
(10) Pub. No.: US 2009/0262087 A1
(43) Pub. Date: Oct. 22, 2009

(54) TERMINAL AND METHOD FOR RECOGNIZING IMAGE THEREIN

(75) Inventor: Jong Hwan KIM, Suwon-si (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/357,962

(22) Filed: Jan. 22, 2009

(30) Foreign Application Priority Data
Apr. 22, 2008 (KR) 10-2008-0037088

(51) Int. Cl. G06F 3/041

(52) U.S. Cl. 345/173

(57) ABSTRACT

In a terminal including a touchscreen, a controller senses a touch to a first point of an image displayed on the touchscreen, recognizes an image part corresponding to the first point and performs an image recognition correcting operation relevant to the recognized image part corresponding to the first point. A method of recognizing an image in the terminal includes displaying the image on a screen, sensing a touch to a first point of the displayed image, recognizing an image part corresponding to the first point upon sensing the touch to the first point and performing an image recognition correcting operation relevant to the recognized image part corresponding to the first point.

### CROSS-REFERENCE TO RELATED APPLICATION

This application claims the benefit of the Korean Patent Application No. 10-2008-0037088, filed on Apr. 22, 2008, which is hereby incorporated by reference as if fully set forth herein.

1. Field of the Invention

The present invention relates to a terminal and a method of recognizing an image in the terminal. Although the present invention is suitable for a wide scope of applications, it is particularly suitable for a terminal having a touch screen.

2. Discussion of the Related Art

A terminal may be configured to perform various functions. Examples of such functions include data and voice communications, capturing images and video via a camera, recording audio, playing music files via a speaker system, and displaying images and video on a display. Some terminals include additional functionality which supports game playing, while other terminals are configured as multimedia players. More recently, terminals have been configured to receive broadcast and multicast signals which permit viewing of content such as videos and television programs.

Efforts are ongoing to support and increase the functionality of terminals. Such efforts include software and hardware improvements, as well as changes and improvements in the structural components which form the terminal.

The related art terminal recognizes a specific object of an image, such as a face, displayed on a screen and displays the recognized specific object of the image distinctively. However, according to the related art, the specific object is not recognized at all or a different part is recognized as the specific object.

Further, the related art terminal recognizes a specific object of an image displayed on a screen and displays identification information on the recognized specific object. However, according to the related art, when the specific object is not recognized correctly, identification information that does not match the specific object may be displayed.

### SUMMARY OF THE INVENTION

According to an embodiment of the present invention, a terminal includes a touchscreen and a controller, and the controller senses a touch to a first point of an image displayed on the touchscreen, recognizes an image part corresponding to the first point and performs an image recognition correcting operation relevant to the recognized image part corresponding to the first point. Preferably, the touch includes at least one of a direct touch onto the touchscreen or a proximity touch to the touchscreen.

In one aspect of the present invention, the controller detects the recognized image part corresponding to the first point from the displayed image as the image recognition correcting operation. Preferably, the terminal further includes an output unit announcing that the image part corresponding to the first point has been detected.

In one aspect of the present invention, the controller senses sequential touches to the first point and a second point of the displayed image as the image recognition correcting operation, cancels detection of the image part corresponding to the first point, and recognizes and detects an image part corresponding to the second point. Preferably, the terminal further includes an output unit announcing that the image part corresponding to the second point has been detected.

In one aspect of the present invention, the terminal further includes a memory for storing at least one image, wherein the controller searches the memory for an image matching the recognized image part corresponding to the first point upon sensing the touch to the first point, and controls the touchscreen to output matching information between the recognized image part corresponding to the first point and the searched image using the searched image. The controller sets identification information of the recognized image part corresponding to the first point using the output matching information in the image recognition correcting operation.

In one aspect of the present invention, the matching information includes at least one of the searched image, a name of the searched image and a matching rate with the searched image. The memory stores an image including the set identification information of the image part according to a control signal from the controller.

In one aspect of the present invention, the touchscreen displays the set identification information according to a control signal from the controller upon sensing the touch to the first point. The touchscreen also displays a list of at least one application executable in association with the set identification information according to a control signal from the controller if sensing the touch to the first point.

In one aspect of the present invention, the terminal further includes a user input unit enabling a specific application to be selected from the displayed list, wherein the controller executes the specific application selected via the user input unit. The controller performs the image recognition correcting operation in at least one of a photo taking mode, a still/moving picture search mode, a broadcast output mode, a video communication mode or a video message mode.

In an embodiment of the present invention, a method of recognizing an image in a terminal includes displaying the image on a screen, sensing a touch to a first point of the displayed image, recognizing an image part corresponding to the first point upon sensing the touch to the first point and performing an image recognition correcting operation relevant to the recognized image part corresponding to the first point. The method may further include detecting the recognized image part corresponding to the first point from the displayed image as the image recognition correcting operation.

In one aspect of the present invention, the method further includes sensing sequential touches to the first point and a second point of the displayed image, wherein detection of the image part corresponding to the first point is cancelled and an image part corresponding to the second point is recognized and detected in the image recognition correcting operation when performing the image recognition correcting operation. The method may further includes searching a memory for an image matching the recognized image part corresponding to the first point upon sensing the touch to the first point and outputting matching information between the recognized image part corresponding to the first point and the searched image using the searched image, wherein identification information of the recognized image part corresponding to the first point is set using the output matching information when performing the image recognition correcting operation.

Preferably, the matching information includes at least one of the searched image, a name of the searched image or a matching rate with the searched image. The method may further include displaying a list of at least one application executable in association with the set identification information of the image part upon sensing the touch to the first point, enabling a specific application to be selected from the displayed list, and executing the selected specific application.

### BRIEF DESCRIPTION OF THE DRAWINGS

The above and other features and advantages of the present invention will become more apparent by describing in detail preferred embodiments thereof with reference to the attached drawings.

FIG. 1 is a block diagram of a terminal according to an embodiment of the present invention.

FIG. 2 is a perspective view of a front side of a terminal according to an embodiment of the present invention.

FIG. 3 is a rear view of the terminal shown in FIG. 2.

FIG. 4 is a block diagram of a CDMA wireless communication system operable with the terminal of FIGS. 1-3.

FIG. 5 is a flowchart illustrating recognizing an image in a terminal according to an embodiment of the present invention.

FIGS. 6A to 7B show screen configurations for detecting an image part corresponding to a touched point from a preview image while capturing an image with a terminal according to an embodiment of the present invention.

FIGS. 8A to 9B show screen configurations for detecting an image part corresponding to a touched point from an image while searching still pictures in a terminal according to an embodiment of the present invention.

FIGS. 10A to 11B show screen configurations for detecting an image part corresponding to a touched point from an image while searching moving pictures in a terminal according to an embodiment of the present invention.

FIGS. 12A to 13B show screen configurations for detecting an image part corresponding to a touched point from an image of a broadcast being output from a terminal according to an embodiment of the present invention.

FIGS. 14A to 15B show screen configurations for detecting an image part corresponding to a touched point from an image while performing video communication in a terminal according to an embodiment of the present invention.

FIGS. 16A to 17 show screen configurations for detecting an image part from a preview image while capturing an image with a terminal according to an embodiment of the present invention, wherein a plurality of points of the image are touched.

FIGS. 18A to 19 show screen configurations for detecting an image part from an image while searching still pictures in a terminal according to an embodiment of the present invention, wherein a plurality of points of the image are touched.

FIGS. 20A to 21 show screen configurations for detecting an image part from an image of a broadcast being output from a terminal according to an embodiment of the present invention, wherein a plurality of points of the image are touched.

FIGS. 22A to 23 show screen configurations for detecting an image part from an image while performing video communication in a terminal according to an embodiment of the present invention, wherein a plurality of points of the image are touched.

FIGS. 24A to 26 show screen configurations for setting identification information corresponding to a touched point from an image while searching still pictures in a terminal according to an embodiment of the present invention.

FIGS. 27A to 29 show screen configurations for setting identification information corresponding to a touched point from an image of a broadcast being output from a terminal according to an embodiment of the present invention.

FIGS. 30A to 32 show screen configurations for setting identification information corresponding to a touched point from an image while performing video communication in a terminal according to an embodiment of the present invention.

FIGS. 33A to 34 show screen configurations for displaying identification information of an image part corresponding to a touched point while displaying an image in a terminal according to an embodiment of the present invention.

FIGS. 35A and 35B show screen configurations for displaying an application list related to an image part corresponding to a touched point while displaying an image in a terminal according to an embodiment of the present invention.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

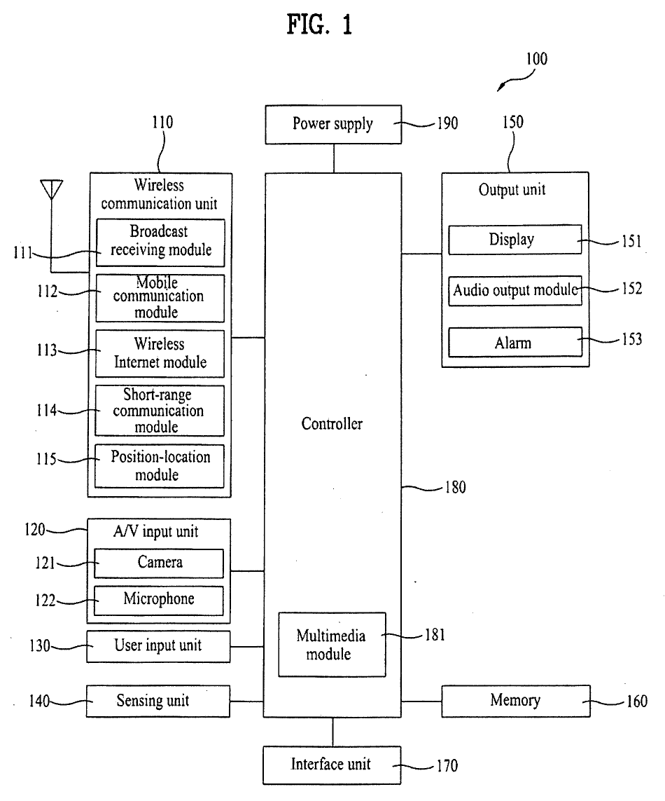

FIG. 1 is a block diagram of terminal 100 in accordance with an embodiment of the present invention. The terminal may be implemented using a variety of different types of terminals. Examples of such terminals include mobile phones, user equipment, smart phones, computers, digital broadcast terminals, personal digital assistants, portable multimedia players (PMP) and navigators. By way of non-limiting example only, further description will be with regard to a terminal. However, such teachings apply similarly to other types of terminals. FIG. 1 shows the terminal 100 having various components, but it is understood that implementing all of the illustrated components is not a requirement. Greater or fewer components may alternatively be implemented.

FIG. 1 shows a wireless communication unit 110 configured with several commonly implemented components. For example, the wireless communication unit 110 typically includes one or more components which permit wireless communication between the terminal 100 and a wireless communication system or network within which the terminal is located.

The broadcast receiving module 111 receives a broadcast signal and/or broadcast associated information from an external broadcast managing entity via a broadcast channel. The broadcast channel may include a satellite channel and a terrestrial channel. The broadcast managing entity refers generally to a system which transmits a broadcast signal and/or broadcast associated information. Examples of broadcast associated information include information associated with a broadcast channel, a broadcast program, and a broadcast service provider. For example, broadcast associated information may include an electronic program guide (EPG) of digital multimedia broadcasting (DMB) and electronic service guide (ESG) of digital video broadcast-handheld (DVB-H).

The broadcast signal may be implemented as a TV broadcast signal, a radio broadcast signal, and a data broadcast signal, among others. If desired, the broadcast signal may further include a broadcast signal combined with a TV or radio broadcast signal.

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Receiving of multicast signals is also possible. If desired, data received by the broadcast receiving module 111 may be stored in a suitable device, such as memory 160.

The mobile communication module 112 transmits/receives wireless signals to/from one or more network entities such as base station and Node-B. Such signals may represent audio, video, multimedia, control signaling, and data, among others.

The wireless internet module 113 supports Internet access for the terminal 100. This module may be internally or externally coupled to the terminal 100.

The short-range communication module 114 facilitates relatively short-range communications. Suitable technologies for implementing this module include radio frequency identification (RFID), infrared data association (IrDA), ultra-wideband (UWB), as well as the networking technologies commonly referred to as Bluetooth and ZigBee, to name a few.

Position-location module 115 identifies or otherwise obtains the location of the terminal 100. If desired, this module may be implemented using global positioning system (GPS) components which cooperate with associated satellites, network components, and combinations thereof.

Audio/video (A/V) input unit 120 is configured to provide audio or video signal input to the terminal 100. As shown, the A/V input unit 120 includes a camera 121 and a microphone 122. The camera receives and processes image frames of still pictures or video.

The microphone 122 receives an external audio signal while the portable device is in a particular mode, such as phone call mode, recording mode and voice recognition. This audio signal is processed and converted into digital data. The portable device, and in particular, A/V input unit 120, typically includes assorted noise removing algorithms to remove noise generated in the course of receiving the external audio signal. Data generated by the A/V input unit 120 may be stored in memory 160, utilized by output unit 150, or transmitted via one or more modules of communication unit 110. If desired, two or more microphones and/or cameras may be used.

The user input unit 130 generates input data responsive to user manipulation of an associated input device or devices. Examples of such devices include a keypad, a dome switch, a jog wheel, a jog switch, and a touchpad such as static pressure/capacitance. A specific example is a touchscreen in which the user input unit 130 is configured as a touchpad in cooperation with a display.

Touchscreen receives a direct touch or a proximity touch, such as an indirect touch or an approximate touch, from an external environment and is then able to perform an information input/output operation corresponding to the received touch. The proximate touch means a virtual touch in a space using a pointer or a user's finger when the pointer is spaced apart by a predetermined distance from an image on the touchscreen.

The terminal 100 senses a proximity touch and a proximity touch pattern, such as a proximity touch distance, a proximity touch direction, a proximity touch speed, a proximity touch time, a proximity touch position, and a proximity touch shift state, and outputs information corresponding to the sensed proximity touch action and the detects proximity touch pattern on the touchscreen.

A proximity sensor is a sensor for sensing a proximity touch and a proximity touch pattern and may include the sensing unit 140 shown in FIG. 1. For example, the proximity sensor includes a photoelectric sensor. In particular, the photoelectric sensor includes a transmissive type photoelectric sensor, a direct reflective type photoelectric sensor, or a mirror reflective photoelectric sensor. The proximity sensor includes a radio frequency oscillation type proximity sensor, an electrostatic capacity type proximity sensor, a magnetic proximity sensor, or an infrared proximity sensor.

The sensing unit 140 provides status measurements of various aspects of the terminal 100. For example, the sensing unit 140 may sense an open/close status of the terminal 100, relative positioning of components, such as a display and keypad, of the terminal, a change of position of the terminal or a component of the terminal, presence or absence of a user contact with the terminal, and orientation or acceleration/deceleration of the terminal.

When the terminal 100 is configured as a slide-type terminal, the sensing unit 140 may sense whether a sliding portion of the terminal is open or closed. The sensing unit 140 may also sense the presence or absence of power provided by the power supply 190, the presence or absence of a coupling or other connection between the interface unit 170 and an external device.

The interface unit 170 is often implemented to couple the terminal 100 with external devices. Typical external devices include wired/wireless headphones, external chargers, power supplies, earphones, microphones, and storage devices configured to store data, such as audio, video, and pictures. The interface unit 170 may be configured using a wired/wireless data port, a card socket for coupling to a memory card, a subscriber identity module (SIM) card, a user identity module (UIM) card, a removable user identity module (RUIM) card), audio input/output ports and video input/output ports.

The output unit 150 generally includes various components which support the output requirements of the terminal 100. The display 151 is typically implemented to visually display information associated with the terminal 100. For example, if the 100 is operating in a phone call mode, the display will generally provide a user interface or graphical user interface which includes information associated with placing, conducting, and terminating a phone call. As another example, if the terminal 100 is in a video call mode or a photographing mode, the display 151 may additionally or alternatively display images which are associated with these modes.

One particular implementation includes the display 151 configured as a touchscreen working in cooperation with an input device, such as a touchpad. This configuration permits the display to function both as an output device and an input device.

The display 151 may be implemented using known display technologies including, for example, a liquid crystal display (LCD), a thin film transistor-liquid crystal display (TFT-LCD), an organic light-emitting diode display (OLED), a flexible display and a three-dimensional display. The terminal 100 may include one or more of such displays. An example of a two-display embodiment is one in which one display is configured as an internal display, which is viewable when the terminal 100 is in an opened position, and a second display configured as an external display, which is viewable in both the open and closed positions.

FIG. 1 further shows output unit 150 having an audio output module 152 which supports the audio output requirements of the terminal 100. The audio output module is often implemented using one or more speakers, buzzers, other audio producing devices, and combinations thereof. The audio output module functions in various modes including call-receiving mode, call-placing mode, recording mode, voice recognition mode and broadcast reception mode. During operation, the audio output module 152 outputs audio relating to a particular function, for example, call received, message received, and errors.

The output unit 150 is further shown having an alarm 153, which is commonly used to signal or otherwise identify the occurrence of a particular event associated with the terminal 100. Typical events include call received, message received and user input received. An example of such output includes the tactile sensations or vibration of the terminal 100. For example, the alarm 153 may be configured to vibrate responsive to the terminal 100 receiving a call or message. As another example, vibration is provided by alarm 153 responsive to receiving user input at the terminal 100, thus providing a tactile feedback mechanism. It is understood that the various output provided by the components of output unit 150 may be separately performed, or such output may be performed using any combination of such components.

The memory 160 is generally used to store various types of data to support the processing, control, and storage requirements of the terminal 100. Examples of such data include program instructions for applications operating on the terminal 100, contact data, phonebook data, messages, pictures, and video. The memory 160 shown in FIG. 1 may be implemented using any type or combination of suitable volatile and non-volatile memory or storage devices including random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, card-type memory, or other similar memory or data storage device.

The controller 180 typically controls the overall operations of the terminal 100. For example, the controller performs the control and processing associated with voice calls, data communications, video calls, camera operations and recording operations. If desired, the controller may include a multimedia module 181 which provides multimedia playback. The multimedia module may be configured as part of the controller 180, or this module may be implemented as a separate component.

The power supply 190 provides power required by the various components for the portable device. The provided power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory 160, and executed by a controller 180 or processor.

The terminal 100 may be implemented in a variety of different configurations. Examples of such configurations include folder-type, slide-type, bar-type, rotational-type, swing-type and combinations thereof. For clarity, further disclosure will primarily relate to a slide-type terminal. However, such teachings apply similarly to other types of terminals.

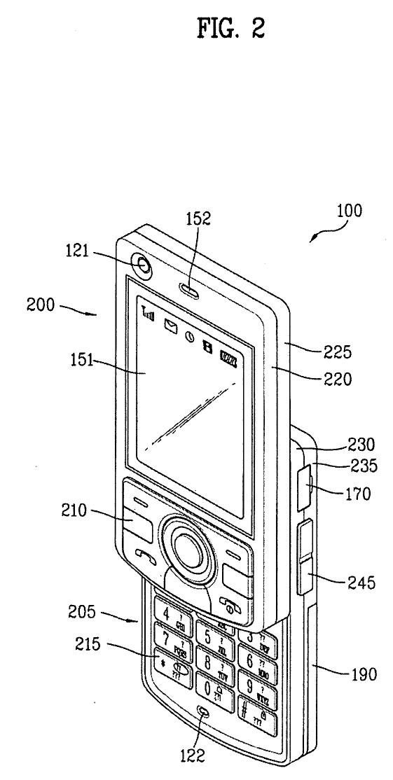

FIG. 2 is a perspective view of a front side of a terminal 100 according to an embodiment of the present invention. In FIG. 2, the terminal 100 has a first body 200 configured to slideably cooperate with a second body 205. The user input unit described in FIG. 1 is implemented using function keys 210 and keypad 215. The function keys 210 are associated with first body 200, and the keypad 215 is associated with second body 205. The keypad includes various keys, such as numbers, characters, and symbols, to enable a user to place a call, prepare a text or multimedia message, and otherwise operate the terminal 100.

The first body 200 slides relative to second body 205 between open and closed positions. In a closed position, the first body 200 is positioned over the second body 205 in such a manner that the keypad 215 is substantially or completely obscured by the first body 200. In the open position, user access to the keypad 215, as well as the display 151 and function keys 210, is possible. The function keys are convenient to a user for entering commands such as start, stop and scroll.

The terminal 100 is operable in either a standby mode or an active call mode. Typically, the terminal 100 functions in a standby mode in the closed position such that the terminal is able to receive a call or message, receive and respond to network control signaling and an active mode in the open position. This mode configuration may be changed as required or desired.

The first body 200 is shown formed from a first case 220 and a second case 225, and the second body 205 is shown formed from a first case 230 and a second case 235. The first and second cases 220, 225, 230, and 235 are usually formed from a suitably rigid material such as injection molded plastic, or formed using metallic material such as stainless steel (STS) and titanium (Ti).

If desired, one or more intermediate cases may be provided between the first and second cases of one or both of the first and second bodies 200, 205. The first and second bodies 200, 205 are typically sized to receive electronic components necessary to support operation of the terminal 100.

The first body 200 is shown having a camera 121 and audio output unit 152, which is configured as a speaker, positioned relative to the display 151. If desired, the camera 121 may be constructed in such a manner that it can be selectively positioned relative to first body 200 by rotation or swivel.

The function keys 210 are positioned adjacent to a lower side of the display 151. The display 151 is shown implemented as an LCD or OLED. As described earlier, the display 151 may also be configured as a touchscreen having an underlying touchpad which generates signals responsive to user contact with the touchscreen by a finger or stylus.

Second body 205 is shown having a microphone 122 positioned adjacent to keypad 215, and side keys 245, which are one type of a user input unit, positioned along the side of second body 205. Preferably, the side keys 245 may be configured as hot keys, such that the side keys are associated with a particular function of the terminal 100. An interface unit 170 is shown positioned adjacent to the side keys 245, and a power supply 190 in a form of a battery is located on a lower portion of the second body 205.

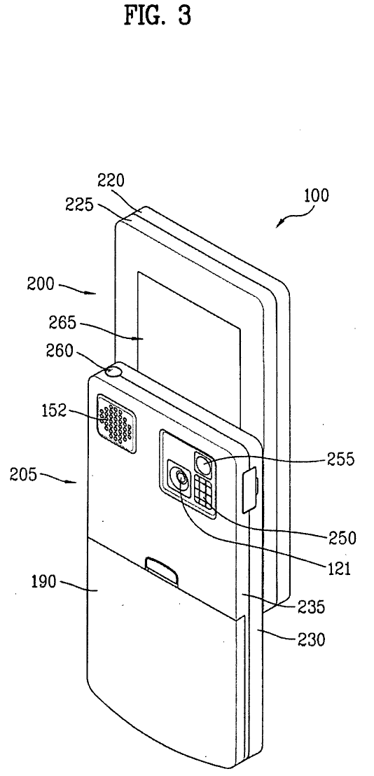

FIG. 3 is a rear view of the terminal 100 shown in FIG. 2. FIG. 3 shows the second body 205 having a camera 121, and an associated flash 250 and mirror 255. The flash 250 operates in conjunction with the camera 121 of the second body 205. The mirror 255 is useful for assisting a user to position the camera 121 in a self-portrait mode. The camera 121 of the second body 205 faces a direction which is opposite to a direction faced by camera 121 of the first body 200 shown in FIG. 1. Each of the cameras 121 of the first and second bodies 200 and 205 may have the same or different capabilities.

In an embodiment, the camera 121 of the first body 200 operates with a relatively lower resolution than the camera 121 of the second body 205. Such an arrangement works well during a video conference, for example, in which reverse link bandwidth capabilities may be limited. The relatively higher resolution of the camera 121 of the second body 205 is useful for obtaining higher quality pictures for later use or for communicating to others.

The second body 205 also includes an audio output module 152 configured as a speaker, and which is located on an upper side of the second body. If desired, the audio output modules of the first and second bodies 200 and 205, may cooperate to provide stereo output. Moreover, either or both of these audio output modules may be configured to operate as a speakerphone.

A broadcast signal receiving antenna 260 is shown located at an upper end of the second body 205. Antenna 260 functions in cooperation with the broadcast receiving module 111 (FIG. 1). If desired, the antenna 260 may be fixed or configured to retract into the second body 205. The rear side of the first body 200 includes slide module 265, which slideably couples with a corresponding slide module located on the front side of the second body 205.

It is understood that the illustrated arrangement of the various components of the first and second bodies 200, 205, may be modified as required or desired. In general, some or all of the components of one body may alternatively be implemented on the other body. In addition, the location and relative positioning of such components are not critical to many embodiments, and as such, the components may be positioned at locations which differ from those shown by the representative figures.

The terminal 100 of FIGS. 1-3 may be configured to operate within a communication system which transmits data via frames or packets, including both wireless and wired communication systems, and satellite-based communication systems. Such communication systems utilize different air interfaces and/or physical layers.

Examples of such air interfaces utilized by the communication systems include for example, frequency division multiple access (FDMA), time division multiple access (TDMA), code division multiple access (CDMA), universal mobile telecommunications system (UMTS), the long term evolution (LTE) of the UMTS, and the global system for mobile communications (GSM). By way of non-limiting example only, further description will relate to a CDMA communication system, but such teachings apply similarly to other system types.

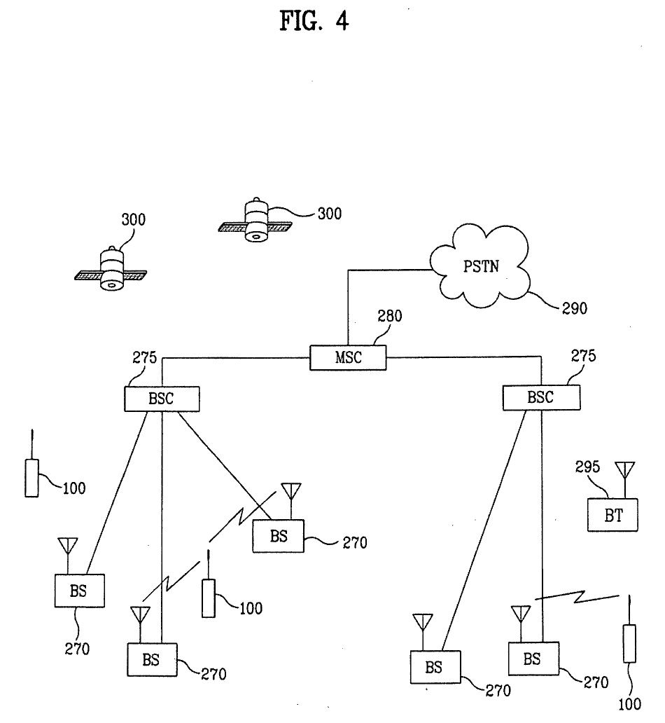

Referring now to FIG. 4, a CDMA wireless communication system is shown having a plurality of terminals 100, a plurality of base stations 270, base station controllers (BSCs) 275, and a mobile switching center (MSC) 280. The MSC 280 is configured to interface with a conventional public switch telephone network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system may include more than two BSCs 275.

Each base station 270 may include one or more sectors, each sector having an omni-directional antenna or an antenna pointed in a particular direction radially away from the base station. Alternatively, each sector may include two antennas for diversity reception. Each base station 270 may be configured to support a plurality of frequency assignments, with each frequency assignment having a particular spectrum, for example 1.25 MHz or 5 MHz.

The intersection of a sector and frequency assignment may be referred to as a CDMA channel. The base stations 270 may also be referred to as base station transceiver subsystems (BTSs). In some cases, the term “base station” may be used to refer collectively to a BSC 275, and one or more base stations 270. The base stations 270 may also be denoted “cell sites.” Alternatively, individual sectors of a given base station 270 may be referred to as cell sites.

A broadcasting transmitter 295 is shown broadcasting to the terminals 100 operating within the system. The broadcast receiving module 111 of the terminal 100 is typically configured to receive broadcast signals transmitted by the broadcasting transmitter 295. Similar arrangements may be implemented for other types of broadcast and multicast signaling.

FIG. 4 further depicts several global positioning system (GPS) satellites 300. Such satellites facilitate locating the position of some or all of the terminals 100. While two satellites are depicted in FIG. 4, it is to be understood that useful positioning information may be obtained with greater or fewer satellites. The position-location module 115 of the terminal 100 is typically configured to cooperate with the satellites 300 to obtain desired position information. It is to be appreciated that other types of position detection technology, for example, a location technology that may be used in addition to or instead of GPS location technology, may alternatively be implemented. If desired, some or all of the GPS satellites 300 may alternatively or additionally be configured to provide satellite DMB transmissions.

During typical operation of the wireless communication system, the base stations 270 receive sets of reverse-link signals from various terminals 100. The terminals 100 are engaging in calls, messaging, and other communications. Each reverse-link signal received by a given base station 270 is processed within that base station 270. The resulting data is forwarded to an associated BSC 275. The BSC 275 provides call resource allocation and mobility management functionality including the orchestration of soft handoffs between base stations 270. The BSCs 275 also route the received data to the MSC 280, which provides additional routing services for interfacing with the PSTN 290. Similarly, the PSTN interfaces with the MSC 280, and the MSC interfaces with the BSCs 275, which in turn controls the base stations 270 to transmit sets of forward-link signals to the terminals 100.

Generally, image recognizing techniques include a detection technique, a tracking technique, and an identification technique. In particular, the detection technique is a technique for detecting an image part corresponding to a specific object, such as a face, from an image such as a camera preview image. The detection technique may be used to detect a plurality of objects from a single image. An area of the detected image part may be displayed using a looped curve such as a quadrangle and a circle.

The tracking technique is a technique for detecting a specific object by continuously tracking the specific object according to a motion of the specific object after an image part corresponding to the specific object has been detected from an image. The tracking technique may be used to track a plurality of objects of a single image and the detected image part may have a different position in each consecutive image according to the motion of the specific object.

The identification technique is a technique for determining whether an image or an image part corresponding to a specific object of the image matches one of previously stored images by comparing the image or the image part to the previously stored images.

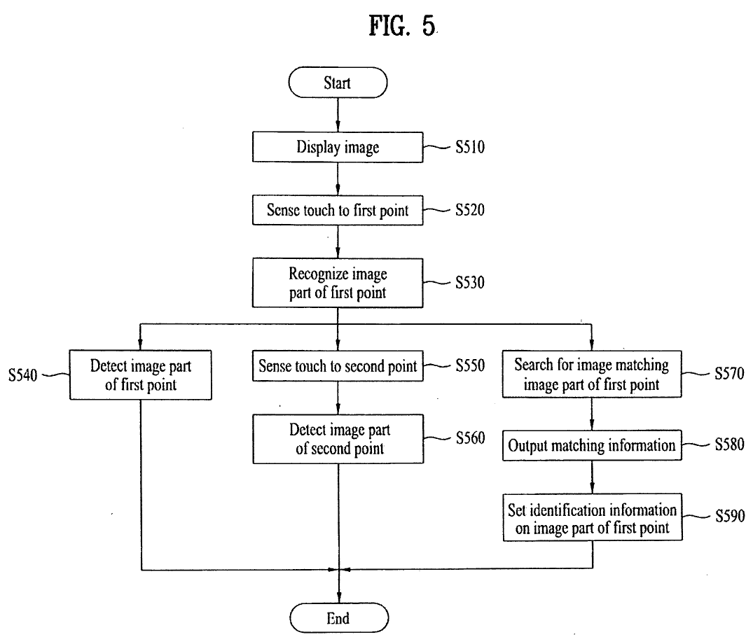

Recognizing an image in a terminal 100 according to an embodiment of the present invention is illustrated in FIG. 5. Referring to FIG. 5, the terminal 100 displays an image on a touchscreen [S510]. As mentioned in the foregoing description, the touchscreen senses a direct touch or a proximity touch, including an indirect touch, an approximate touch, and a haptic touch, and may subsequently display information corresponding to the sensed touch. The terminal 100 may include a sensor for sensing the direct or proximity touch onto the touchscreen.

When the terminal 100 enters at least one of a photo taking mode, a still/moving picture search mode, a broadcast output mode, a video call mode, and a video message mode, the terminal subsequently displays an image corresponding to the entered mode on the display 151. For example, a preview image is displayed in the photo taking mode. A still or moving picture being searched or browsed is displayed in the still/moving picture search mode. An image corresponding to a picture from the broadcast being output is displayed in the broadcast output mode. A correspondent party image or a user image is displayed in the video call mode. And, an image included in a transmitted/received video message is displayed in the video message mode.

If a touch is input to a first point in the image displayed in S510, the terminal 100 senses the touch to the first point [S520]. The terminal 100 may detect the touch using a detecting sensor provided to the sensing unit 140 or the touchscreen. When the touch to the first point is sensed in S520, the terminal 100 recognizes an image part (hereinafter called ‘first image part’) corresponding to the first point [S530] and may perform various recognition correcting operations related to the recognized first image part.

In the following description, various image recognition correcting operations according to an embodiment of the present invention are described with reference to the accompanying drawings. When a user selects a menu item for image recognition correction, the terminal 100 performs the following image recognition correcting operation.

According to an embodiment of the present invention, as a part of the image recognition correcting operation, the terminal 100 senses the touch to the first point [S520] and then detects the recognized first image part from the image displayed in S510 [S540]. Detection of the recognized first image part is not performed before the touch to the first point.

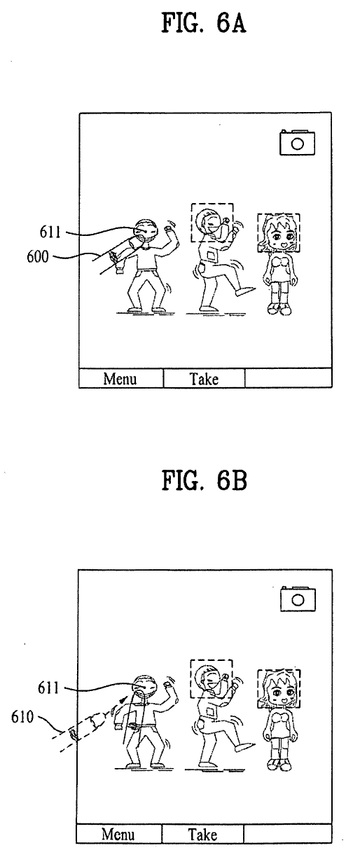

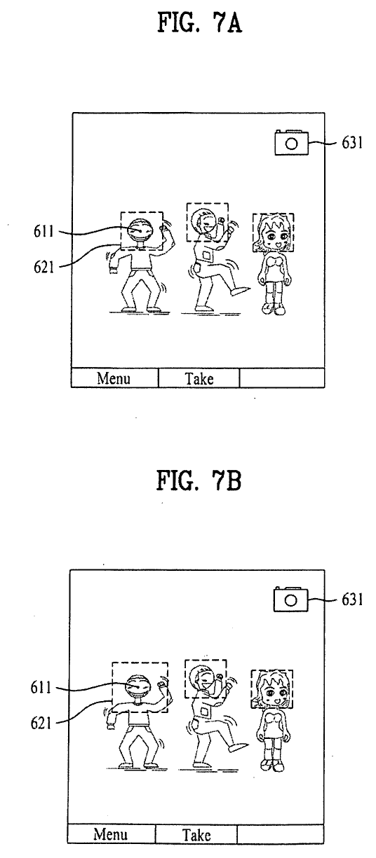

In the following description, screen configurations for recognizing and detecting an image part corresponding to a touched point from a preview image while capturing an image or taking a picture in the terminal 100 are explained with reference to FIGS. 6A to 7B.

Referring to FIG. 6A, in the still/moving picture capturing mode, the terminal 100 receives a direct touch input 600 from a user onto a first point 611 in a preview image displayed on the touchscreen.

Referring to FIG. 6B, in the still/moving picture capturing mode, the terminal 100 receives a proximity touch input 610 from a user onto a first point 611 in a preview image displayed on the screen. For example, the proximity touch may be recognized when a pointer or a user's finger approaches the first point 611 and the pointer is positioned within a predetermined distance from the first point. Alternatively, the proximity touch may be recognized when a predetermined period of time lapses while the pointer is positioned within a predetermined distance from the first point 611 or when a touch action for selecting the first point is input while the pointer is positioned within a predetermined distance from the first point.

Referring to FIG. 7A, as illustrated in FIG. 6A or FIG. 6B, when the touch input to the first point 611 is sensed, the terminal 100 recognizes and detects a first image part 621 and then marks an area of the image part. Afterward, if a command signal (hereinafter ‘detection cancel signal’) for canceling the detection of the first image part 621 is input via the touchscreen, the terminal 100 deletes the marked area for the first image part shown in FIG. 7A. For example, in case of the direct touch input 600, the detection cancel signal may include a touch signal of a predetermined count/duration/pressure/size for a portion of the screen, specifically, the first image part 621, or a touch action signal for the detection cancellation. Alternatively, the detection cancel signal may be generated by a proximity touch input if a pointer is positioned within a predetermined distance from the screen, if a predetermined period of time lapses while a pointer is positioned within a predetermined distance from the screen, or if an action for detection cancellation is input while the pointer is positioned within a predetermined distance from the screen.

When an area setting action on the screen via a direct touch input 600 or a proximity touch input 610 is sensed as shown in FIGS. 6A and 6B, the terminal 100 sets the screen part corresponding to the area setting action to the first image part 621 as shown in FIG. 7A.

Referring to FIG. 7B, in case of the direct touch input 600, the terminal 100 sets an area of the first image part 621 by enlarging the area in proportion to a touch duration/size/pressure/count. In case of the proximity touch input, if the distance between the pointer and the screen becomes equal to or smaller than a predetermined distance, if a predetermined period of time lapses while the pointer is positioned in the predetermined distance, or if a proximity touch action for an area extension is input, the terminal 100 sets the area of the first image part 621 by enlarging the area.

In particular, in case of the proximity touch input, as the proximity touch or the pointer approaches closer to the screen or a proximity touch duration becomes longer, the terminal 100 may sequentially display the images shown in FIG. 6B, FIG. 7A and FIG. 7B. The terminal 100 may also set the area of the first image part 621 by reducing the area according to the received touch signal. When a capturing key 631 provided to a prescribed area of the screen, as shown in FIG. 7A and FIG. 7B, is activated, the terminal 100 captures or photograph an image, maintaining the detected first image part 621. The above described features in the still/moving picture capturing mode will also equally or similarly apply to other modes described below.

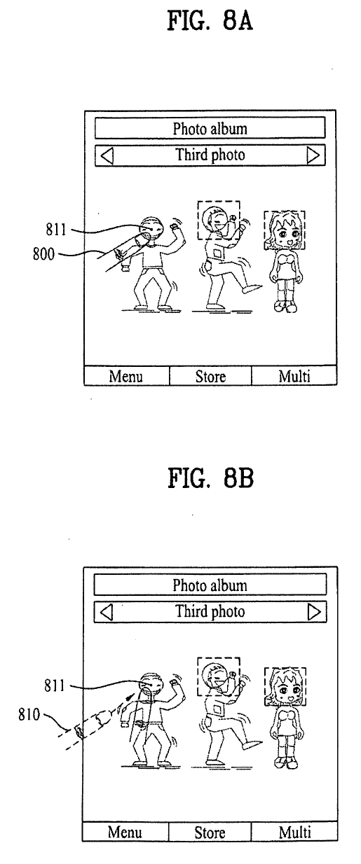

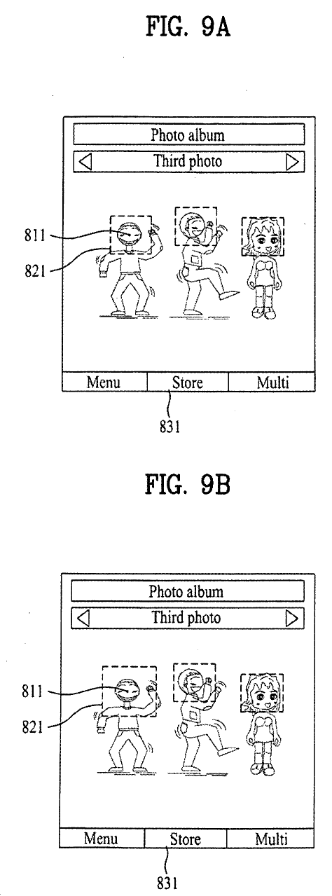

In the following description, screen configurations for recognizing and detecting an image part corresponding to a touched point from an image while searching still pictures in the terminal 100 are described with reference to FIGS. 8A to 9B.

Referring to FIG. 8A or FIG. 8B, in the still picture search mode, a direct 800 or proximity 810 touch input to a first point 811 of a still picture displayed on the screen is received by the terminal 100.

Referring to FIG. 9A, when the touch input to the first point 811 is sensed as described in FIG. 8A or FIG. 8B, the terminal 100 recognizes and detects a first image part 821 and marks an area of the first image part. When a detection cancel signal for the first image part 821 is input via the touchscreen, the terminal 100 deletes the marked area for the first image part shown in FIG. 9A as described above referring to FIG. 7A or FIG. 7B.

When an area setting action on the screen via direct 800 or proximity 810 touch input is sensed as shown in FIG. 8A or FIG. 8B, the terminal 100 sets the screen part corresponding to the area setting action to the first image part 821 as shown in FIG. 9A.

Referring to FIG. 9B, in case of the direct touch input 800, the terminal 100 sets an area of the first image part 821 by enlarging the area in proportion to a touch duration/size/pressure/count. In case of the proximity touch input 610, if the distance between the pointer and the screen becomes equal to or smaller than a predetermined distance, if a predetermined period of time lapses while the pointer is positioned in the predetermined distance, or if a proximity touch action for an area extension is input, the terminal 100 sets the area of the first image part 821 by enlarging the area.

In particular, in case of the proximity touch input, as the proximity touch or the pointer approaches closer to the screen or a proximity touch duration becomes longer, the terminal 100 may sequentially display the images shown in FIG. 8B, FIG. 9A and FIG. 9B. The terminal 100 may also set the area of the first image part 821 by reducing the area according to the received touch signal. When a capturing key or ‘Store’ key 831 provided to a prescribed area of the screen, as shown in FIG. 9A or FIG. 9B, is activated, the terminal 100 stores the image, maintaining the detected first image part 821.

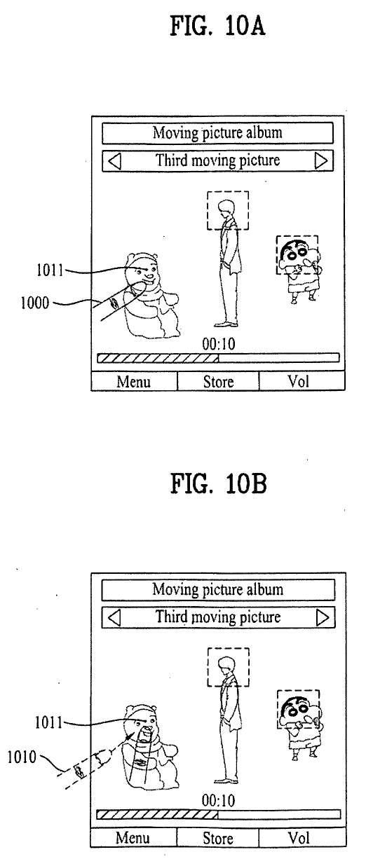

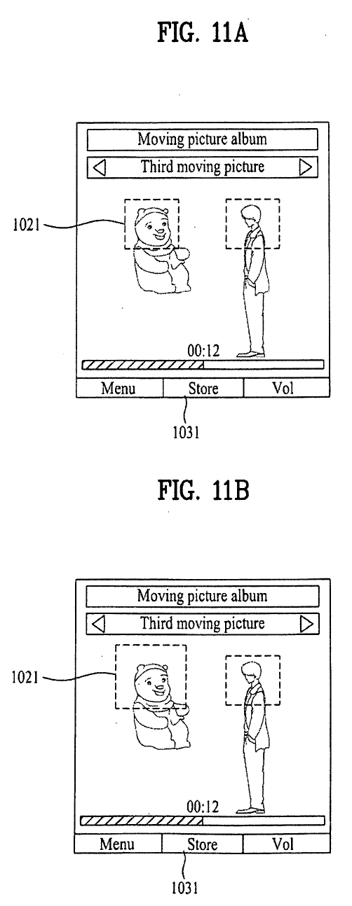

In the following description, screen configurations for recognizing and detecting an image part corresponding to a touched point from an image while searching moving pictures in the terminal 100 are described with reference to FIGS. 10A to 11B. FIGs.

Referring to FIG. 10A or FIG. 10B, in the moving picture search mode, a direct 1000 or proximity 1010 touch onto a first point 1011 of a currently output image is input to the terminal 100 by a user while viewing a moving picture.

Referring to FIG. 11A, when the touch input to the first point 1011 shown in FIG. 10A or FIG. 10B is sensed, the terminal 100 recognizes and detects a first image part 1021 and marks an area of the first image part 1021. In the moving picture, since output images are continuously changed during the playback, the terminal 100 keeps recognizing and detecting the first image part 1021 from a plurality of sequentially displayed images using the above described tracking technique. When an area setting action on the screen via the direct 1000 or proximity 1010 touch input is sensed, the terminal 100 sets the screen part corresponding to the area setting action to the first image part 1021.

Referring to FIG. 11B, in case of the direct touch 1000, the terminal 100 sets an area of the first image part 1021 by enlarging the area in proportion to a touch duration/size/pressure/count. In case of the proximity touch 1010, if the distance between the pointer and the screen becomes equal to or smaller than a predetermined distance, if a predetermined period of time lapses while the pointer is positioned in the predetermined distance, or if a proximity touch action for an area extension is input, the terminal 100 sets the area of the first image part 1021 by enlarging the area.

In particular, in case of the proximity touch input 1010, as the proximity touch or the pointer approaches closer to the screen or the proximity touch duration becomes longer, the terminal 100 may sequentially display the images shown in FIG. 10B, FIG. 11A and FIG. 11B. When a capturing key or “Store” key 1031 provided to a prescribed area of the screen, as shown in FIG. 11A and FIG. 11B, is activated, the terminal 100 stores the moving picture, maintaining the detected first image part 1021.

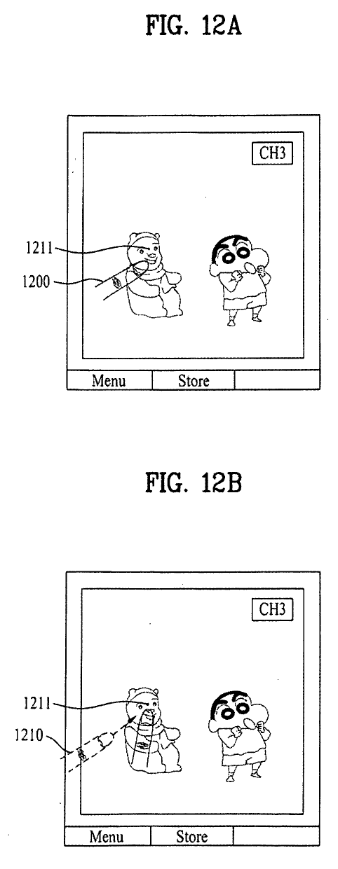

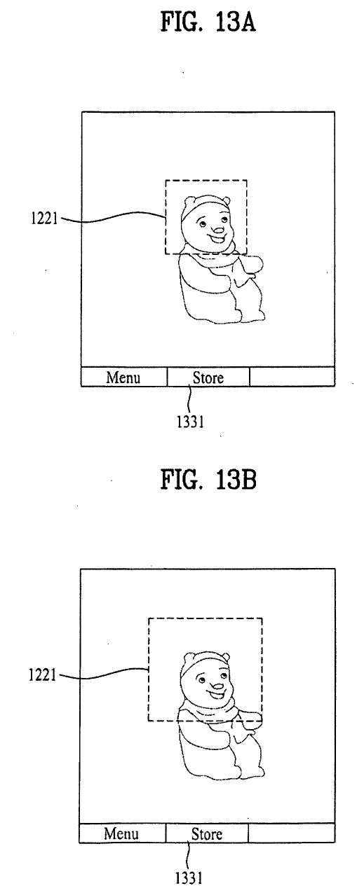

In the following description, screen configurations for recognizing and detecting an image part corresponding to a touched point from an image while a broadcast is being output in the terminal 100 are described with reference to FIGS. 12A to 13B.

Referring to FIG. 12A or FIG. 12B, in the broadcast output mode, a direct 1200 or proximity 1210 touch input to a first point 1211 of an image corresponding to a currently output broadcast signal is input to the terminal 100 by a user while viewing the broadcasting.

Referring to FIG. 13A, when the touch input to the first point 1211, shown in FIG. 12A or FIG. 12B, is sensed, the terminal 100 recognizes and detects a first image part 1221 and marks an area of the first image part 1221. In the broadcasting mode, since output images are continuously changed according to a real-time broadcast output, the terminal 100 recognizes and detects the first image part 1221 from a plurality of sequentially displayed images using the tracking technique.

Referring to FIG. 13B, in case of the direct touch 1200, the terminal 100 sets an area of the first image part 1221 by enlarging the area in proportion to a touch duration/size/pressure/count. In case of the proximity touch input 1210, if the distance between the pointer and the screen becomes equal to or smaller than a predetermined distance, if a predetermined period of time lapses while the pointer is positioned in the predetermined distance, or if a proximity touch action for an area extension is input, the terminal 100 sets the area of the first image part 1221 by enlarging the area.

In particular, in case of the proximity touch input, as the proximity touch or the pointer approaches closer to the screen or a proximity touch duration becomes longer, the terminal 100 may sequentially display the images shown in FIG. 12B, FIG. 13A and FIG. 13B. When a capturing key or ‘Store’ 1331 provided to a prescribed area of the screen, as shown in FIG. 13A and FIG. 13B, is activated, the terminal 100 stores the moving picture, maintaining the detected first image part 1221.

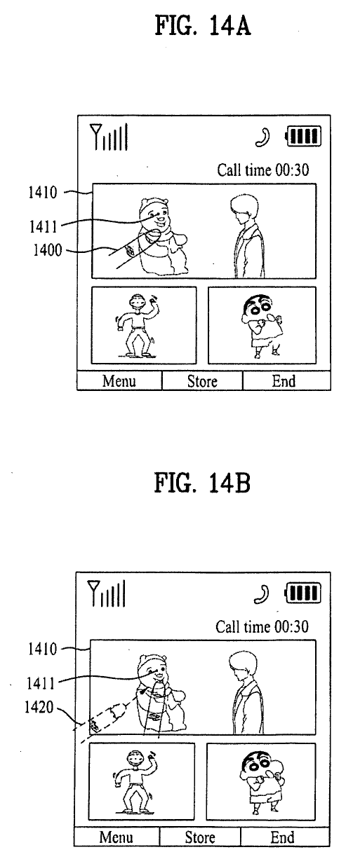

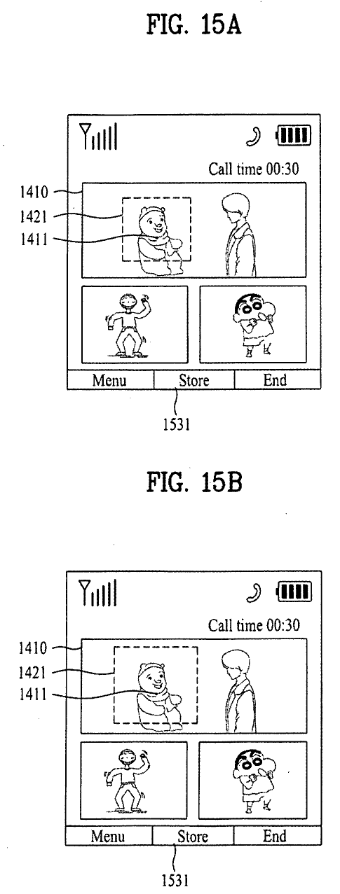

In the following description, screen configurations for recognizing and detecting an image part corresponding to a touched point from an image while performing video call or communication in the terminal 100 are explained with reference to FIGS. 14A to 15B.

Referring to FIG. 14A or FIG. 14B, in the video communication mode, a direct 1400 or proximity 1420 touch input onto a first point 1411 of an image 1410 corresponding to a picture of a correspondent party is input to the terminal 100 by a user. The same is applicable not only to the correspondent party but also to the user's picture.

Referring to FIG. 15A, if the touch input to the first point 1411, shown in FIG. 14A or FIG. 14B, is sensed, the terminal 100 recognizes and detects a first image part 1421 and marks an area of the first image part 1421.

Referring to FIG. 15B, in case of the direct touch 1400, the terminal 100 sets an area of the first image part 1421 by enlarging the area in proportion to a touch duration/size/pressure/count. In case of the proximity touch input 1420, if the distance between the pointer and the screen becomes equal to or smaller than a predetermined distance, if a predetermined period of time lapses while the pointer is positioned in the predetermined distance, or if a proximity touch action for an area extension is input, the terminal 100 sets the area of the first image part 1421 by enlarging the area.

In particular, in case of the proximity touch input, as the proximity touch or the pointer approaches closer to the screen or a proximity touch duration becomes longer, the terminal 100 may sequentially display the images shown in FIG. 14B, FIG. 15A and FIG. 15B. When a capturing key or “Store” 1531 provided to a prescribed area of the screen, as shown in FIG. 15A and FIG. 15B, is activated, the terminal 100 stores the moving picture, maintaining the detected first image part 1421.

Referring to FIG. 5, according to another embodiment of the present invention, in an image recognition correcting operation, the terminal 100 senses sequential touches to first and second points [S520, S550], cancels the detection of the first image part from the image displayed in S510, and recognizes and detects an image part (hereinafter ‘second image part’) corresponding to the second point [S560]. The first image part may be detected prior to the touches to the first and second points. For example, the first image part may be an image part that a user or the terminal 100 does not intend to detect.

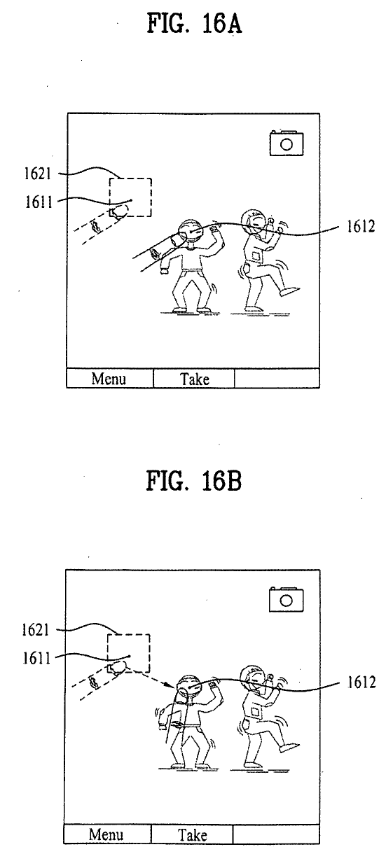

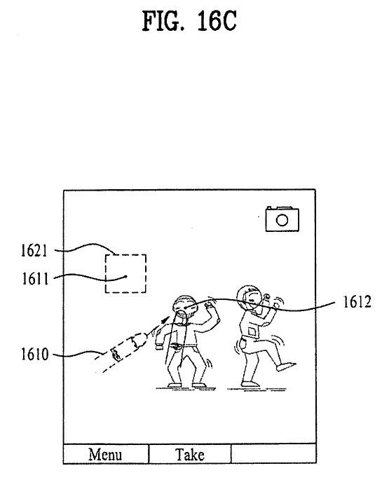

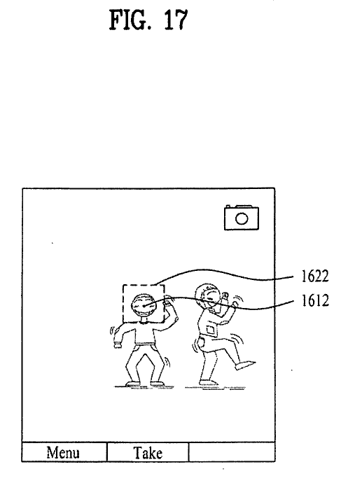

Screen configurations for recognizing and detecting an image part in the terminal 100 when a plurality of points of a preview image are touched while capturing an image are described with reference to FIGS. 16A to 17. Capturing the image may be still picture capturing or moving picture capturing. For clarity and convenience of the following description, the image capturing is exemplified by the still picture capturing.

FIGS. 16A to 17 show screen configurations for detecting an image part from a preview image while capturing an image in the terminal 100 according to an embodiment of the present invention, wherein a plurality of points of the image are touched.

Referring to FIGS. 16A to 16C, sequential touches to first and second points 1611 and 1612 of a preview image received via the camera 121 are input to the terminal 100 by a user. The first point 1611 may be a random point of a detected first image part 1621.

Details of the sequential touches are described as follows. First, having touched the first point 1611, the user touches the second point 1612 within a predetermined period of time, as shown in FIG. 16A, and performs a touch and drag action from the first point 1611 to the second point 1612, as shown in FIG. 16B, or applies a proximity touch input 1610 to the second point 1612, as shown in FIG. 16C. For example, the proximity touch is recognized when a distance between a pointer and the second point 1612 is equal to or smaller than a predetermined distance, when a predetermined period of time lapses at a predetermined distance, or when a touch action for selecting the second point is input at a predetermined distance between the pointer and the second point.

As the sequential touches are input, the terminal 100 cancels an image detection of the first image part 1621 and then recognizes and detects an image part 1622 corresponding to the second point 1612 (hereinafter ‘second image part’), as shown in FIG. 17. In one aspect of the present invention, the terminal 100 may adjust a size of the second image part 1622 according to a direct touch size/duration/pressure/count for the second point 1612 or a proximity touch duration/distance/action for the second point 1612.

When the second image part 1622 is detected, the terminal 100 marks an area corresponding to the second image part or performs an alarm action through vibration, alarm sound, or lamp by using the alarm unit 153. Moreover, if a ‘storage key area’ provided to a prescribed area of the screen is activated, the terminal 100 stores the detected image of the second image part 1622 in the memory 160. The above described features with regard to image capturing, as illustrated in FIGS. 16A-17 are equally or similarly applicable to the following description with regard to searching pictures, broadcast output, and video communication.

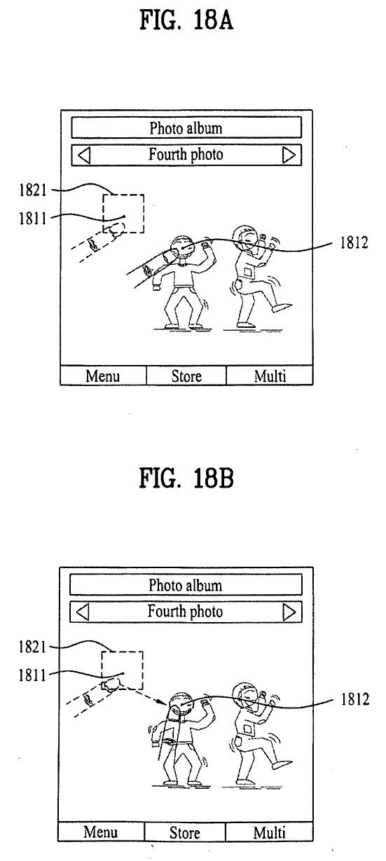

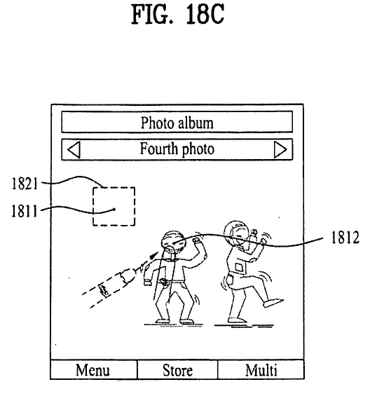

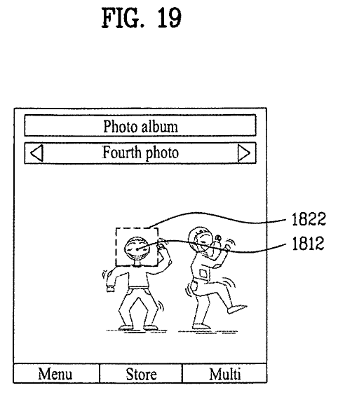

Screen configurations for recognizing and detecting an image part in the terminal 100 when a plurality of points of an image are touched while searching still pictures are described with reference to FIGS. 18A to 19. The description of FIGS. 18A to 19 with regard to the still pictures is also applicable to a moving picture search.

Referring to FIGS. 18A to 18C, sequential touches to first and second points 1811 and 1812 of a still picture displayed on the screen are input to the terminal 100 by a user. The first point 1811 may be a random point of a detected first image part 1821. Details of the sequential touches, shown in FIGS. 18A to 18C, are equivalent to those described with reference to FIGS. 16A to 16C.

As the sequential touches are input as shown in FIGS. 18A to 18C, the terminal 100 cancels an image detection of the first image part 1821 and then recognizes and detects an image part 1822 corresponding to the second point 1812, as shown in FIG. 19.

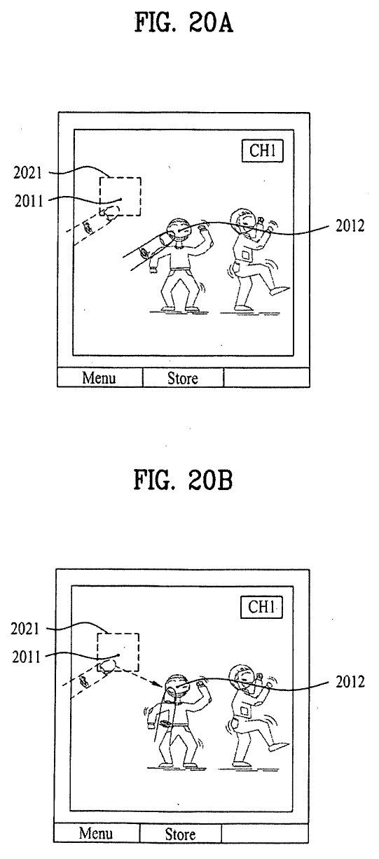

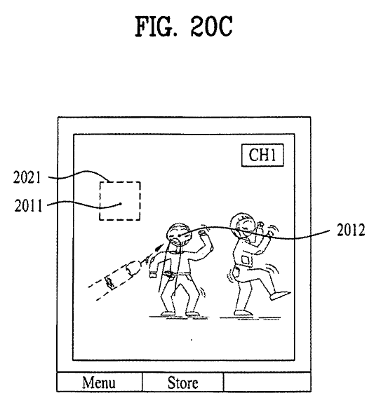

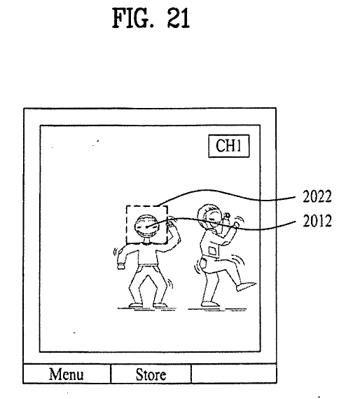

In the following description, screen configurations for recognizing and detecting an image part in the terminal 100 when a plurality of points of an image are touched while outputting a broadcast are described with reference to FIGS. 20A to 21.

Referring to FIGS. 20A to 20C, sequential touches to first and second points 2011 and 2012 of an image displayed according to a broadcast output are input to the terminal 100 by a user. The first point 2011 may be a random point of a detected first image part 2021. Details of the sequential touches illustrated in FIGS. 20A to 20C are equivalent to those described with reference to FIGS. 16A to 16C.

As the sequential touches are input as shown in FIGS. 20A to 20C, the terminal 100 cancels an image detection of the first image part 2021 and then recognizes and detects an image part 2022 corresponding to the second point 2012, as shown in FIG. 21.

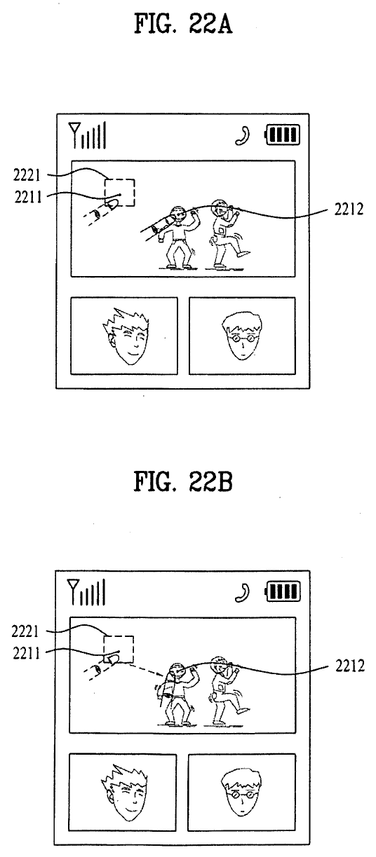

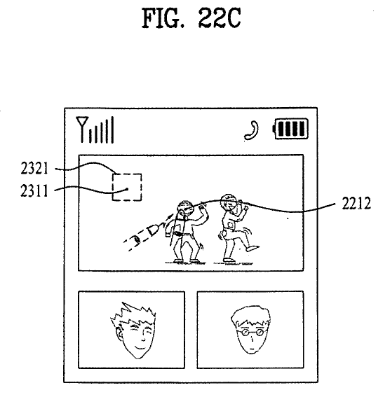

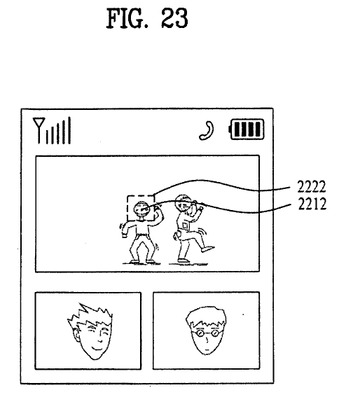

In the following description, screen configurations for recognizing and detecting an image part in the terminal 100 when a plurality of points of an image are touched while performing video communication or video calls are described with reference to FIGS. 22A to 23. The image may be at least one of a correspondent's image or the user's image.

Referring to FIGS. 22A to 22C, sequential touches to first and second points 2211 and 2212 of an image displayed during video communication are input to the terminal 100 by a user. The first point 2211 may be a random point of a detected first image part 2221. Details of the sequential touches illustrated in FIGS. 22A to 22C are equivalent to those described with reference to FIGS. 16A to 16C.

As the sequential touches are input as shown in FIGS. 22A to 22C, the terminal 100 cancels an image detection of the first image part 2221 and then recognizes and detects an image part 2222 corresponding to the second point 2212, as shown in FIG. 23.

Referring to FIG. 5, according to an embodiment of the present invention, in an image correction operation, the terminal 100 senses a touch to a first point [S520] and then searches the memory 160 for an image that matches a first image part [S570]. In this embodiment, at least one image is stored in the memory 160 and identification information matching the stored at least one image can be set for the corresponding image. The identification information may include a name set for an image, or a name of a folder storing an image, or a name of a correspondent party registered in a phonebook if an image was stored and linked with the phonebook.

In S570, the terminal 100 searches an image matching a first image part using the identification technique. For example, the terminal 100 searches an image including an object determined as equal or similar to an object, such as a face, corresponding to the first image part. In this technique, a matching rate (%) may be used as an equivalence/similarity determination reference and the terminal 100 searches images over a reference matching rate.

Subsequently, the terminal 100 outputs matching information between the first image part and the searched image via the touchscreen using the image searched in S570 [S580]. For example, the matching information includes at least one of a searched image, a name of a searched image and a matching rate with a searched image.

In an image recognition correcting operation, the terminal 100 sets identification information of the first image part using the matching information output in S580 [S590]. Moreover, the memory 160 stores the identification information set for the first image part according to a control signal from the controller 180.

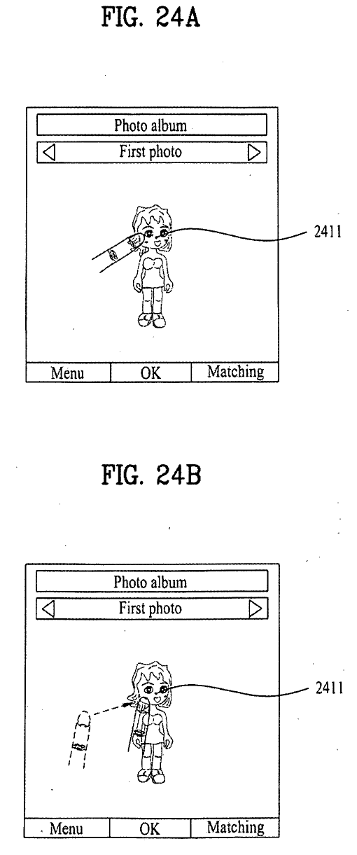

In the following description, screen configurations for setting identification information corresponding to a touched point of an image during a still picture search are described with reference to FIGS. 24A to 26. For clarity and convenience, while the following description is exemplified by a still picture search, the same is applicable to a moving picture search as well.

FIGS. 24A to 26 show screen configurations for setting identification information corresponding to a touched point from an image while searching still pictures in the terminal 100 according to an embodiment of the present invention.

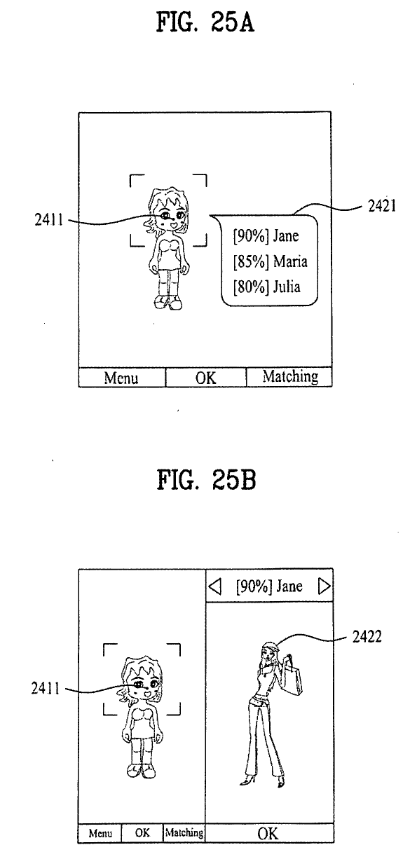

Referring to FIG. 24A or FIG. 24B, while a still picture is displayed, a user inputs a direct touch (FIG. 24A) or a proximity touch (FIG. 24B) to a first point 2411. As the user inputs the touch as shown in FIG. 24A or FIG. 24B, the terminal 100 searches the memory 160 for at least one image matching a first image part corresponding to the first point 2411 and then displays matching information with the searched at least one image on the screen, as shown in FIG. 25A and FIG. 25B.

Referring to FIG. 25A, the terminal 100 displays the matching information including a matching rate with the searched image and identification information set for each searched image. Referring to FIG. 25B, the terminal 100 displays the matching information which includes a matching rate with the searched image, identification information set for each searched image and the searched image on a prescribed area of the screen. The searched image may be displayed as a thumbnail or each of the searched images is sequentially displayed one by one.

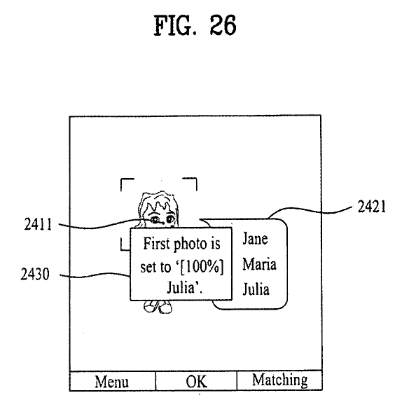

If specific identification information in FIG. 25A or a specific image in FIG. 25B is selected by a user, the terminal 100 sets the selected specific identification information for the first image part or specific identification information set for a selected specific image and sets a matching rate with the specific image, for which the specific identification information is set, to 100%, as shown in FIG. 26. Subsequently, the terminal 100 stores the specific identification information and matching rate set in FIG. 26 in the memory 160 together with the currently displayed image.

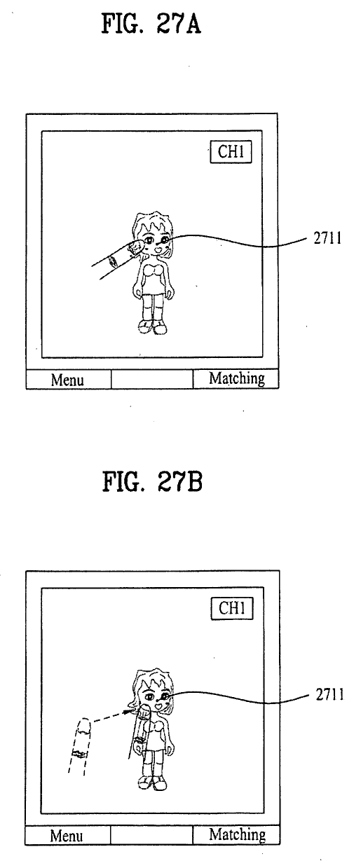

In the following description, screen configurations for setting identification information corresponding to a touched point of an image while outputting a broadcast are described with reference to FIGS. 27A to 29.

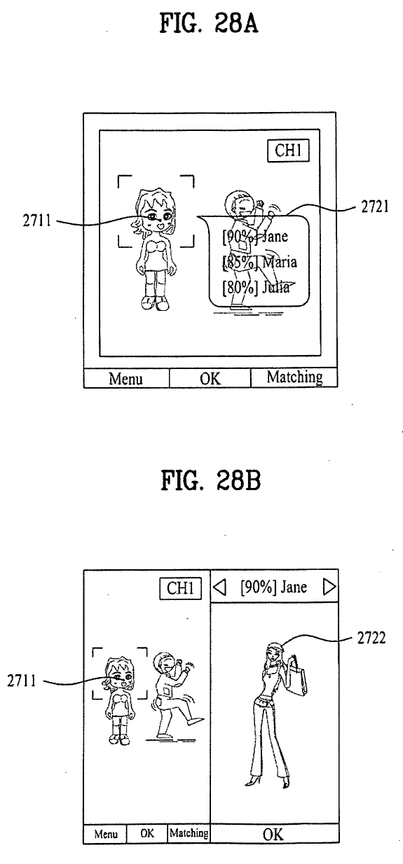

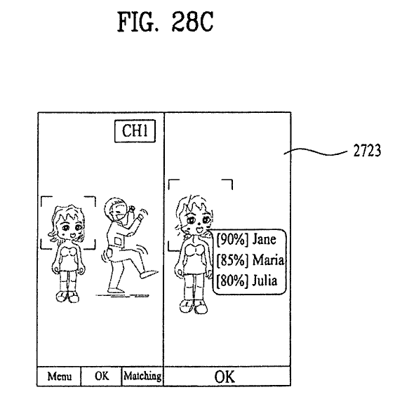

Referring to FIG. 27A or FIG. 27B, while a broadcast picture is displayed, a user inputs a direct touch (FIG. 27A) or a proximity touch (FIG. 27B) to a first point 2711. As the user inputs the touch as shown in FIG. 27A or FIG. 27B, the terminal 100 searches the memory 160 for at least one image matching a first image part corresponding to the first point 2711 and then displays matching information with the searched at least one image on the screen, as shown in FIG. 28A, FIG. 28B, and FIG. 28C. Details of the matching information and the display of the matching information are equivalent to those of the former description with reference to FIG. 25A and FIG. 25B.

Referring to FIG. 28C, the terminal 100 divides the screen into a plurality of areas. The terminal 100 displays a broadcast picture according to a broadcast signal output on the first area and displays a matching information output picture for the first image part on the second area. Accordingly, broadcast viewing is not interrupted.

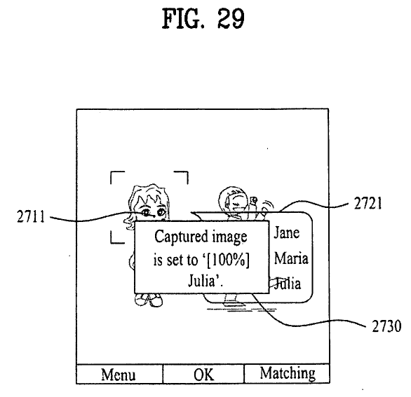

If specific identification information in FIG. 28A or FIG. 28C, or a specific image in FIG. 28B is selected by a user, the terminal 100 sets the selected specific identification information for the first image part or specific identification information set for a selected specific image and sets a matching rate with the specific image, for which the specific identification information is set, to 100%, as shown in FIG. 29. Subsequently, the terminal 100 stores the specific identification information and matching rate set in FIG. 29 in the memory 160 together with the currently displayed image.

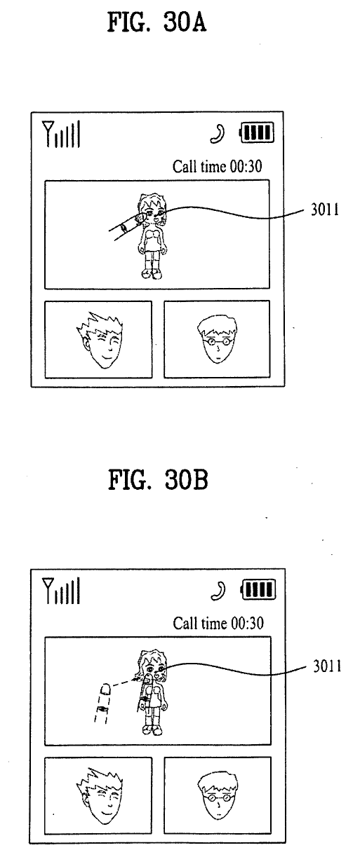

In the following description, screen configurations for setting identification information corresponding to a touched point of an image while performing video communication are described with reference to FIGS. 30A to 32. For clarity and convenience, the following description is exemplified by a correspondent party image. However, it is understood that the same is applicable to a user image as well.

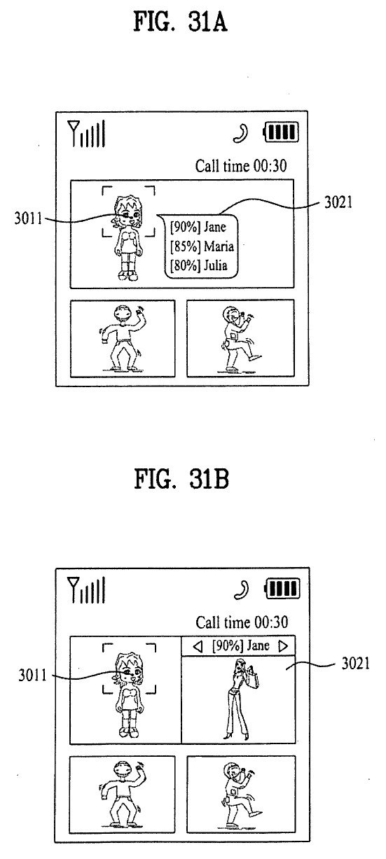

Referring to FIG. 30A or FIG. 30B, while an image according to video communication is displayed, a user inputs a direct touch (FIG. 30A) or a proximity touch (FIG. 30B) to a first point 3011. As the user inputs the touch as shown in FIG. 30A or FIG. 30B, the terminal 100 searches the memory 160 for at least one image matching a first image part corresponding to the first point 3011 and then displays matching information with the searched at least one image on the screen, as shown in FIG. 31A and FIG. 31B.

Details of the matching information and the display of the matching information are equivalent to those of the above description with reference to FIG. 25A and FIG. 25B.

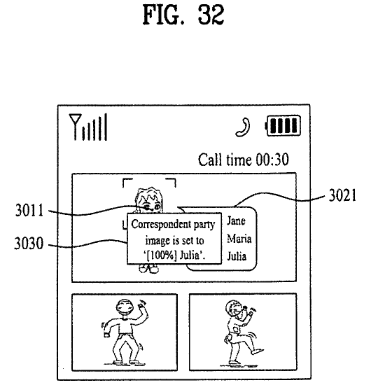

If specific identification information in FIG. 31A or a specific image in FIG. 31B is selected by a user, the terminal 100 sets the selected specific identification information for the first image part or specific identification information set for a selected specific image and sets a matching rate with the specific image, for which the specific identification information is set, to 100%, as shown in FIG. 32. Subsequently, the terminal 100 stores the specific identification information and matching rate set in FIG. 32 in the memory 160 together with the currently displayed image. Alternatively, the matching rate set in FIG. 26, FIG. 29 or FIG. 32 may be set to a value over a predetermined reference instead of 100%.

According to the present invention, if a touch to a first point of a currently displayed image is sensed, the terminal 100 displays identification information set for an image part corresponding to the first point on the touchscreen. For example, only if a user selects a menu item corresponding to an identification information display, the terminal 100 performs an identification information displaying action.

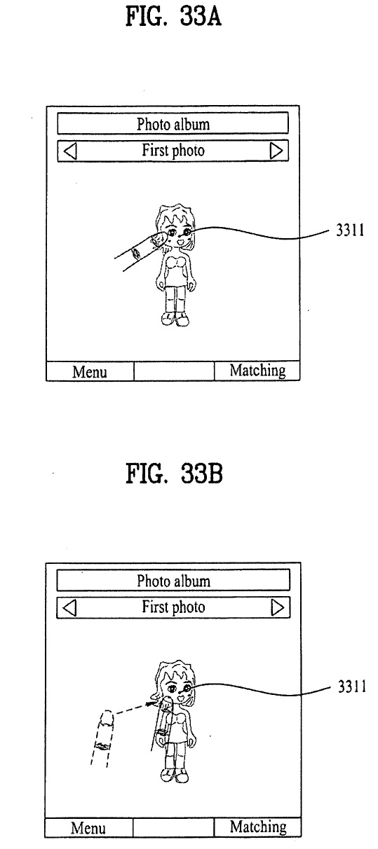

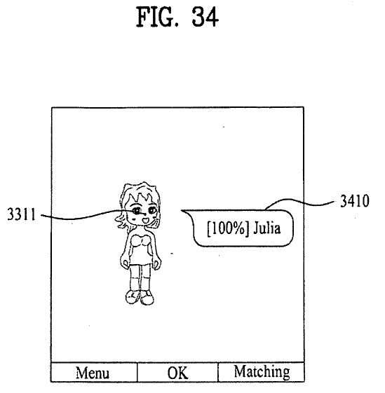

In the following description, screen configurations for displaying identification information of an image part corresponding to a touched point while displaying an image in the terminal 100 are described with reference to FIGS. 33A to 34. For clarity and convenience, the following description is exemplified by a still picture search. However, it is understood that the same is applicable to moving picture search/broadcast picture output/video communication/image capturing as well.

Referring to FIG. 33A or FIG. 33B, a user inputs a direct touch (FIG. 30A) or a proximity touch (FIG. 30B) to a first point 3311 of a currently displayed image. As the touch is input as shown in FIG. 33A or FIG. 33B, the terminal 100 displays identification information set for an image part corresponding to the first point 3311 (hereinafter ‘first image part’) on the screen, as shown in FIG. 34. The terminal 100 displays a matching rate along with a searched image related to the first image part.

According to the present invention, when a touch to a first point of a currently displayed image is sensed, the terminal 100 displays at least one application list executable in association with an image part, for which identification information is set, via the touchscreen. If a specific application is selected from the application list via the user input unit 130, the terminal 100 executes the selected specific application. For example, identification information is set for the image part by the above described method and a matching rate with another image for which identification information is set by the above described method is set to 100%.

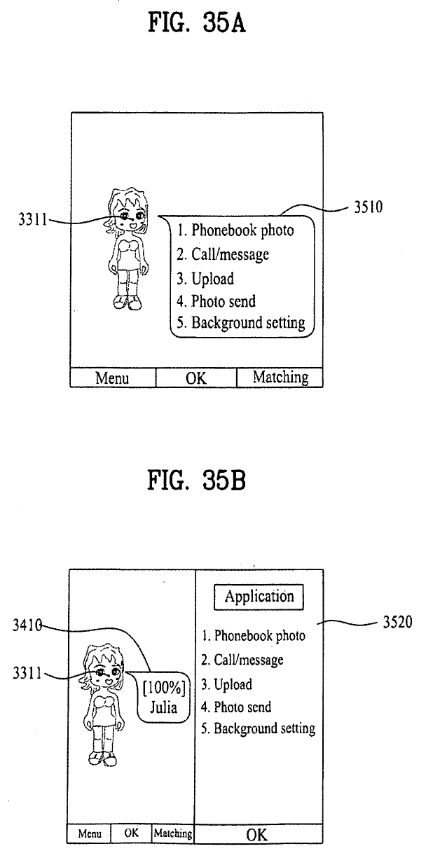

Referring to FIG. 35A or FIG. 35B, the terminal 100 displays an application list 3510 using a word-balloon as shown in FIG. 35A or displays an application list 3520 on a portion of the divided screen as shown in FIG. 35B. For example, the application list may contain phonebook photo, call/message, upload, photo send, and background setting.

If a specific application is selected in FIG. 35A or FIG. 35B, the terminal 100 executes the selected specific application and displays a corresponding picture. For example, if the phonebook photo is selected, the terminal 100 registers an image part as a phonebook photo. If the call/message is selected, the terminal 100 sends a call or message to a correspondent party corresponding to an image part. If the upload is selected, the terminal 100 uploads an image part to an internet server. If the photo send is selected, the terminal 100 sends an image part to a specific correspondent party. If the background setting is selected, the terminal 100 sets a background image of the terminal 100 to an image part.

According to one embodiment of the present invention, the above-described image recognizing method may be implemented in a program recorded medium as computer-readable codes. The computer-readable media include all kinds of recording devices in which data readable by a computer system are stored. For example, the computer-readable media include ROM, RAM, CD-ROM, magnetic tapes, floppy discs, and optical data storage devices and also include carrier-wave type implementations, such as transmission via Internet. And, the computer includes the controller 180 of the terminal 100.

Accordingly, the present invention provides the following effects and/or advantages. First, the present invention facilitates a recognition correction operation for an image to be performed through a touch input. Second, the present invention facilitates a detection or identification operation for an image to be performed according to a user's intention, thereby enabling an image to be recognized by sufficiently reflecting the user's intention. Third, the present invention enables an image part to be quickly recognized while executing an application related to the image part on which an image recognition correction operation has been performed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A terminal comprising:
a touchscreen; and
a controller sensing a touch to a first point of an image displayed on the touchscreen, the controller recognizing an image part corresponding to the first point and performing an image recognition correcting operation relevant to the recognized image part corresponding to the first point.

2. The terminal of claim 1, wherein the controller detects the recognized image part corresponding to the first point from the displayed image as the image recognition correcting operation.

3. The terminal of claim 2, further comprising:
an output unit announcing that the image part corresponding to the first point has been detected.

4. The terminal of claim 1, wherein the controller senses sequential touches to the first point and a second point of the displayed image as the image recognition correcting operation, cancels detection of the image part corresponding to the first point, and recognizes and detects an image part corresponding to the second point.

5. The terminal of claim 4, further comprising:
an output unit announcing that the image part corresponding to the second point has been detected.

6. The terminal of claim 1, further comprising:
a memory for storing at least one image,
wherein the controller searches the memory for an image matching the recognized image part corresponding to the first point upon sensing the touch to the first point, and controls the touchscreen to output matching information between the recognized image part corresponding to the first point and the searched image using the searched image.

7. The terminal of claim 6, wherein the controller sets identification information of the recognized image part corresponding to the first point using the output matching information in the image recognition correcting operation.

8. The terminal of claim 7, wherein the matching information comprises at least one of the searched image, a name of the searched image and a matching rate with the searched image.

9. The terminal of claim 7, wherein the memory stores an image comprising the set identification information of the image part according to a control signal from the controller.

10. The terminal of claim 7, wherein the touchscreen displays the set identification information according to a control signal from the controller upon sensing the touch to the first point.

11. The terminal of claim 7, wherein the touchscreen displays a list of at least one application executable in association with the set identification information according to a control signal from the controller if sensing the touch to the first point.

12. The terminal of claim 11, further comprising:
a user input unit enabling a specific application to be selected from the displayed list,
wherein the controller executes the specific application selected via the user input unit.

13. The terminal of claim 1, wherein the controller performs the image recognition correcting operation in at least one of a photo taking mode, a still/moving picture search mode, a broadcast output mode, a video communication mode or a video message mode.

14. The terminal of claim 1, wherein the touch comprises at least one of a direct touch onto the touchscreen or a proximity touch to the touchscreen.

15. A method of recognizing an image in a terminal, the method comprising:
displaying the image on a screen;
sensing a touch to a first point of the displayed image;
recognizing an image part corresponding to the first point upon sensing the touch to the first point; and
performing an image recognition correcting operation relevant to the recognized image part corresponding to the first point.

16. The method of claim 15, further comprising:
detecting the recognized image part corresponding to the first point from the displayed image as the image recognition correcting operation.

17. The method of claim 15, further comprising:
sensing sequential touches to the first point and a second point of the displayed image,
wherein detection of the image part corresponding to the first point is cancelled and an image part corresponding to the second point is recognized and detected in the image recognition correcting operation when performing the image recognition correcting operation.

18. The method of claim 15, further comprising:
searching a memory for an image matching the recognized image part corresponding to the first point upon sensing the touch to the first point; and
outputting matching information between the recognized image part corresponding to the first point and the searched image using the searched image,
wherein identification information of the recognized image part corresponding to the first point is set using the output matching information when performing the image recognition correcting operation.

19. The method of claim 18, wherein the matching information comprises at least one of the searched image, a name of the searched image or a matching rate with the searched image.

20. The method of claim 18, further comprising:
displaying a list of at least one application executable in association with the set identification information of the image part upon sensing the touch to the first point;
enabling a specific application to be selected from the displayed list; and
executing the selected specific application.
